(19) United States
(12) Patent Application Publication
(10) Pub. No.: US 2003/0222914 A1
(43) Pub. Date: Dec. 4, 2003

(54) Method of and apparatus for setting highlight window using remote controller

(75) Inventor: Jae-cheol Heo, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/396,439

(22) Filed: Mar. 26, 2003

(30) Foreign Application Priority Data
May 29, 2002 (KR) 2002-29958

(51) Int. Cl. G09G 5/00

(52) U.S. Cl. 345/767

(57) ABSTRACT

A method of setting a highlight window using a remote controller and an apparatus therefor includes receiving remote control signals from the remote controller having a highlight selection function, decoding the remote control signals received from the remote controller, generating a highlight window according to highlight setting values when the decoded remote control signals are highlight function codes, and controlling a video parameter for the generated highlight window.

### CROSS-REFERENCE TO RELATED APPLICATIONS

This application claims the benefit of Korean Application No. 2002-29958, filed May 29, 2002, in the Korean Intellectual Property Office, the disclosure of which is incorporated herein by reference.

### BACKGROUND OF THE INVENTION

1. Field of the Invention

The present invention relates to an image reproducing system, and more particularly, to a method of and an apparatus for setting a highlight window using a remote controller.

2. Description of the Related Art

Recently, an image reproducing apparatus can display data on one or more regions on a monitor screen. Here, rectangular regions on the monitor screen are referred to as windows. In addition, the windows on the monitor screen may or may not overlap. A user is required to set a highlight window, e.g., one of the windows, on the screen in order to attract people's interest (attention) on specific data.

In an existing image reproducing apparatus, highlight windows are set using a user control panel. In another existing image reproducing apparatus, the highlight windows are set using a setting device, such as a mouse, via a universal serial bus (USB) when operating a personal computer.

However, since the user control panel is installed in the image reproducing apparatus, it is difficult to manipulate the user control panel. In addition, since the USB cannot be used in a stand-alone type apparatus, it is uncomfortable and inconvenient to use the setting device.

### SUMMARY OF THE INVENTION

The present invention provides a method of setting a highlight window using a remote controller in an image reproducing system.

The present invention also provides an apparatus for setting a highlight window according to a method of setting the highlight window using a remote controller.

Additional aspects and advantages of the invention will be set forth in part in the description which follows and, in part, will be obvious from the description, or may be learned by practice of the invention.

According to an aspect of the present invention, a method of setting a highlight window in an image reproducing system includes receiving remote control signals from a remote controller having a highlight selection function, decoding the remote control signals received from the remote controller, generating the highlight window according to highlight setting values when the decoded remote control signals are highlight function codes, and controlling a video parameter to adjust a video signal displayed in the generated highlight window.

According to another aspect of the present invention, an apparatus for setting a highlight window in an image reproducing system includes a remote control sensor detecting wirelessly transferred functional button codes, which are generated in a remote controller, a control unit checking changes in highlight setting values in an on state of a highlight function when the functional button codes, which are detected in the remote control sensor, are highlight function selection data, an image process unit generating a window corresponding to the highlight setting values on a screen and decoding input video data, and a highlight signal change unit controlling a parameter of the decoded input video data included in the window, which is generated by the image process unit.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a block diagram illustrating an apparatus for setting a highlight window according to an embodiment of the present invention;

FIG. 2 is a flowchart illustrating a method performed in the apparatus shown in FIG. 1 to set the highlight window;

FIG. 3 illustrates an example of an initially set window when a user selects a highlight function in the apparatus shown in FIG. 1; and

FIG. 4 illustrates an example of a previously set window and a newly set window when a user selects a highlight function more than twice in the apparatus shown in FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

The present invention will now be described more fully with reference to the 30 accompanying drawings, in which preferred embodiments of the invention are shown.

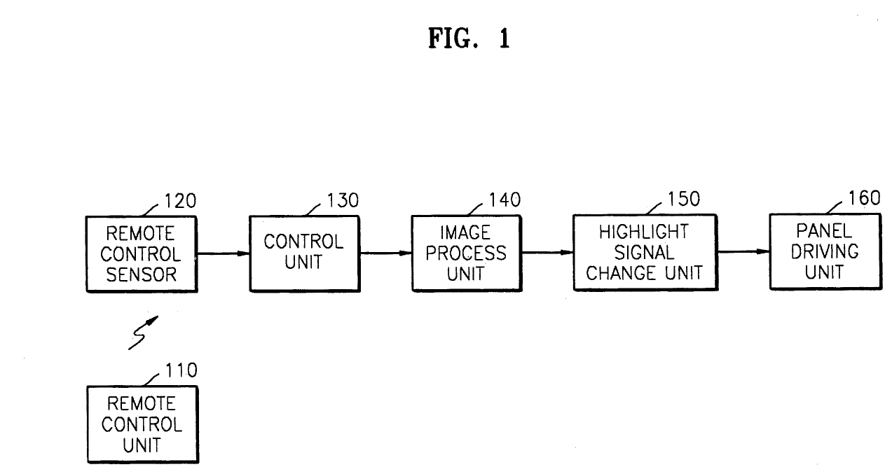

FIG. 1 is a block diagram illustrating an apparatus (image reproducing apparatus) for setting a highlight window according to an embodiment of the present invention. The apparatus of FIG. 1 includes a remote control unit 110, a remote control sensor 120, a control unit 130, an image process unit 140, a highlight signal change unit 150, and a panel driving unit 160.

Referring to FIG. 1, the remote control unit 110 has buttons relating to a highlight function and transfers highlight function codes to a main body of the apparatus using a radio frequency (RF) corresponding to inputs of the buttons. For example, the remote control unit 110 has a highlight on/off button, highlight window size control buttons, and highlight window location control buttons in order to remote control the start and end of the highlight function and set a display screen or the highlight window.

The remote control sensor 120 detects signals relating to the highlight function, which are input from the remote control unit 110, and processes the input signals into electric pulse signals.

The control unit 130 decodes the highlight function codes from the electric pulse signals processed in the remote control sensor 120 and generates highlight setting values corresponding to the decoded highlight function codes. For example, the control unit 130 receives a highlight signal and outputs a size and a location (x, y) of the highlight window. If a user changes the size or the location (x, y) of the highlight window while the highlight function is in an on state, the control unit 130 outputs the changed size and location (x, y) of the highlight window.

The image process unit 140 decodes video signals and generates an on screen display (OSD) of a box shape corresponding to the size and the location (x, y) of the highlight window, which are generated in the control unit 130.

The highlight signal change unit 150 adjusts a parameter of the video signals through the OSD, which is formed in the image process unit 140, by using the size and the location (x, y) of the highlight window, which are generated in the control unit 130. In other words, the highlight signal change unit 150 adjusts an offset or a gain of the video signals in the highlight window to emphasize the video signals included in the highlight window.

The panel driving unit 160 converts RGB signals, which are generated in the highlight signal change unit 150, into low voltage differential signals in order to optimally transfer the RGB signals to a panel.

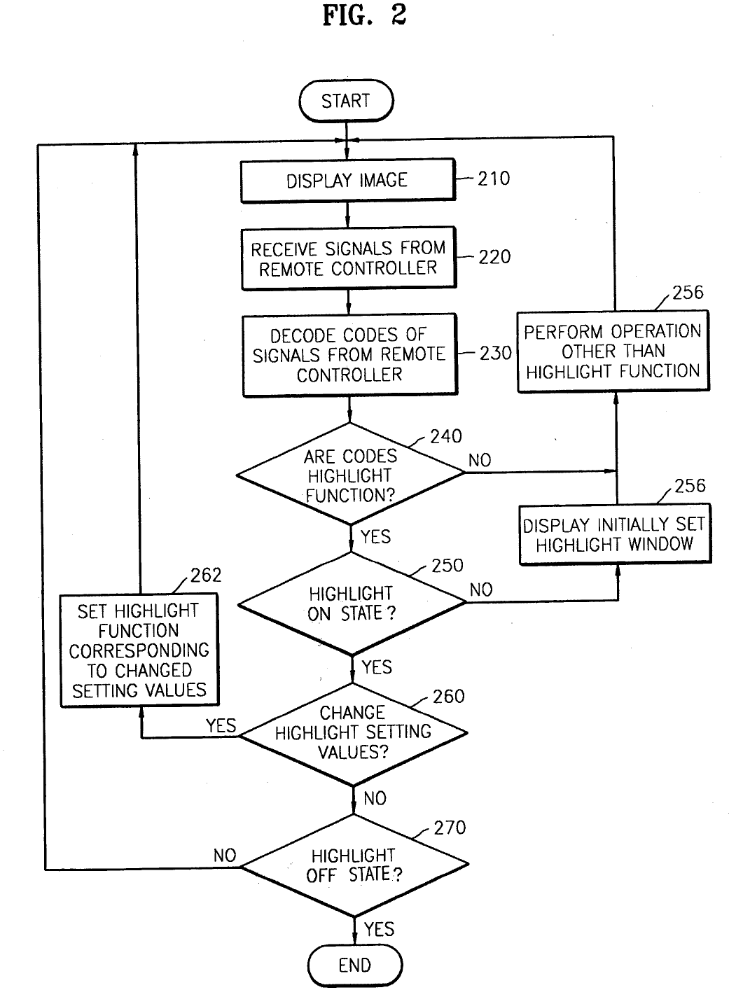

FIG. 2 is a flowchart illustrating a method performed in the apparatus shown in FIG. 1 to set the highlight window.

First, electric power is applied to the image reproducing apparatus to display image signals on a screen in operation 210.

When reproducing images on the screen, the image reproducing apparatus wirelessly receives button signals from the remote control unit (remote controller) 110 having the buttons relating to the highlight function in operation 220.

Thereafter, codes of the wirelessly received button signals are decoded in operation 230. For example, the control unit 130 receives a highlight function on/off signal, a highlight window size change signal, and a highlight window location change signal and decodes the codes of the received signals.

It is checked whether decoded code values are highlight function data in operation 240. Here, if the decoded code values are not the highlight function data, an operation other than the highlight function is performed in operation 256.

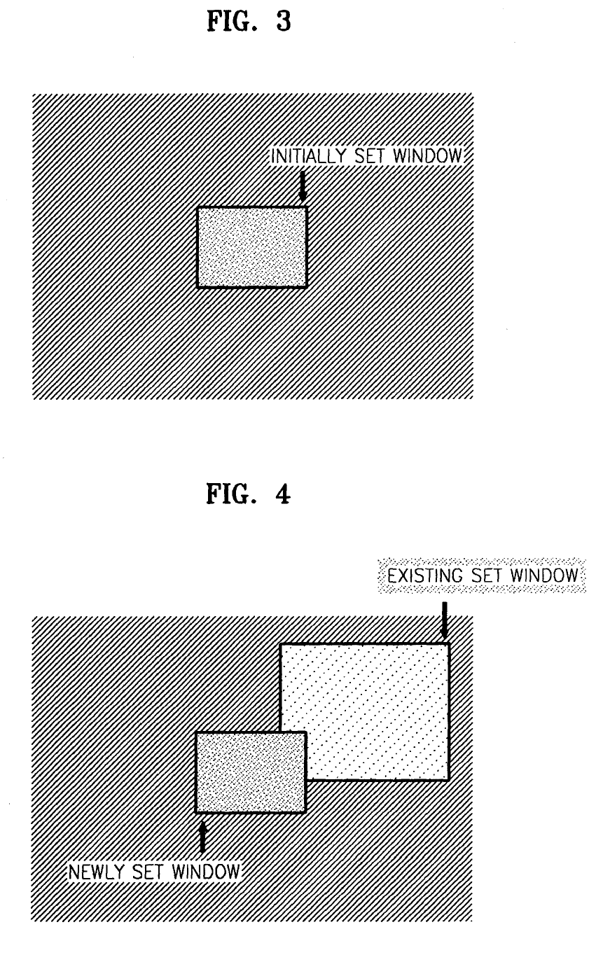

If the decoded code values are the highlight function data, it is checked whether the highlight function is in the on state in operation 250. If the highlight function is in an off state, a box-shaped initial window is displayed at a center of the screen using a predetermined initial highlight value as shown in FIG. 3 in operation 250. Here, the video signals of the image in the box-shaped initial window are compensated using parameter values of predetermined initial signals. Here, the initially set highlight values include size data of the highlight window, location data of the highlight window, and highlight degree data, for example, the offset or gain of the video signals.

When the highlight window function is in the on state, the codes of the wirelessly received button signals are decoded to check whether the highlight setting values, for example, the size and the location of the highlight window, are changed in operation 260. If the highlight setting values are changed, the changed size and location of the highlight window are calculated and the video signals included in the highlight window are compensated using a predetermined signal parameter in operation 262. For example, in order to change the size and the location of the highlight window, the user inputs the size change buttons and the location change buttons of the remote control unit 110. When the user changes the size and the location of the highlight window using the buttons of the remote control unit 110, the control unit 130 recognizes a start location (x1, y1) and an end location (x2, y2) of the highlight window so that the control unit 130 calculates a center point (xo, yo) of the highlight window. Thereafter, the control unit 130 generates a changed highlight window with reference to the center point (xo, yo) of the highlight window. The control unit 130 compensates for the video signals included in the changed highlight window using the predetermined parameter.

When the highlight setting values are not changed, the video parameters of the changed highlight window are renewed until the highlight function is ended in operation 270.

Thereafter, when the user selects a highlight function end button or the button signal is not received from the remote control unit 120 for a predetermined period of time, the finally changed highlight window is stored and the processes are ended.

If the user inputs more than one highlight function button, a new highlight window is generated in addition to the existing highlight window as shown in FIG. 4.

According to the present invention, since the highlight window is set using the remote controller, the user can easily highlight specific regions on the screen from a remote location of the image reproducing apparatus.

While this invention has been particularly shown and described with reference to preferred embodiment thereof, the preferred embodiment described above is merely illustrative and are not intended to limit the scope of the invention. Accordingly, the scope of the present invention will be defined by the appended claims and their equivalents.

What is claimed is:

1. A method of setting a highlight window in an image reproducing system, the method comprising:
receiving remote control signals from a remote controller having a highlight selection function;
decoding the remote control signals received from the remote controller;
generating a highlight window according to highlight setting values when the decoded remote control signals are highlight function codes; and
controlling a video parameter of video signals displayed in the generated highlight window.

2. The method of claim 1, further comprising:
checking whether a highlight function is in an on state when the decoded remote control signals are the highlight function codes; and
displaying an initially set highlight window when the highlight function is in an off state.

3. The method of claim 1, wherein the highlight window setting values comprises:
size and location values.

4. The method of claim 1, wherein the controlling of the video parameter comprises:
controlling an offset and a gain of video signals.

5. The method of claim 1, wherein the generating of the highlight window comprises:
generating more than one window.

6. An apparatus for setting a highlight window in an image reproducing system receiving a signal from a remote controller, the apparatus comprising:
a remote control sensor detecting wirelessly transferred functional codes, which are generated from the remote controller;
a control unit checking highlight setting values in an on state of a highlight function when the functional codes, which are detected in the remote control sensor, are highlight data;
an image process unit generating a window corresponding to the highlight setting values, receiving video data from an external source, and decoding the video data; and
a highlight signal change unit controlling a parameter of the video data included in the window and generated by the image process unit.

7. The apparatus of claim 6, wherein the remote controller comprises a highlight function on/off button, a highlight window size change button, and a highlight window location change button to generate the functional codes having the highlight data.

8. An apparatus for setting a highlight window in an image reproducing system receiving a signal from a remote controller, comprising:
a main body unit receiving a wirelessly transferred highlight functional code generated from the remote controller, and generating a highlight window and video data representing an image to be displayed in the highlight window according to the wirelessly transferred highlight functional code.

9. The apparatus of claim 8, wherein the wirelessly transferred highlight functional code generated from the remote controller comprises:
one of a highlight on/off signal, a highlight window size control signal, a highlight window location control signal, and a video data parameter control signal.

10. The apparatus of claim 8, wherein the image reproducing system is connected to one of an external monitor and an internal monitor each having a screen, and the main body unit adjusts one of a location and a size of the highlight window with respect to the screen.

11. The apparatus of claim 10, wherein the main body unit adjusts the video data according to the adjustment of the one of the location and the size of the highlight window.

12. The apparatus of claim 8, wherein the main body unit comprises:
a remote control sensor detecting the wirelessly transferred highlight functional codes, which are generated from the remote controller;
a control unit decoding the wirelessly transferred highlight functional code to generate a highlight setting value; and
an image process unit generating the highlight window according to the highlight setting value.

13. The apparatus of claim 12, wherein the main body unit further comprises:
a highlight signal change unit adjusting a parameter of the video data to display the image in the highlight window.

14. The apparatus of claim 13, wherein the parameter of the video data comprises:
at least one of an offset and a gain of the video data to emphasize the image included in the highlight window.

15. The apparatus of claim 13, wherein the highlight signal change unit adjusts the image to be displayed in the highlight window according to the adjusted parameter of the video data.

16. The apparatus of claim 13, wherein the image reproducing system is connected to a display panel, and the main body unit further comprises:
a panel driving unit converting the adjusted video data into a low voltage differential signal to optimally transfer the video data to the display panel.

17. The apparatus of claim 13, wherein the image reproducing system is connected to one of an external display panel and an internal panel each having a screen, and the highlight window is displayed on a portion of the screen.

18. The apparatus of claim 17, wherein the highlight signal change unit adjusts the video data to highlight the image displayed in the highlight window more than another image displayed on an outside of the highlight window in the screen.

19. An apparatus for setting a highlight window in an image reproducing system having a display panel with a screen and receiving a signal from a remote controller, comprising:
a main body unit receiving a wirelessly transferred highlight functional code generated from the remote controller, and generating a highlight window having a boundary included in the screen and displayed on the screen according to the wirelessly transferred highlight functional code.

20. An apparatus for setting a highlight window in an image reproducing system receiving a signal from a remote controller, comprising:
a main body unit receiving a wirelessly transferred highlight functional code generated from the remote controller, and generating a first highlight window and a second highlight window according to the wirelessly transferred highlight functional code.

21. The apparatus of claim 20, wherein the main body unit generates first video data representing a first image to be displayed in the first highlight window, and second video data representing a second image to be displayed in the second highlight window according to the wirelessly transferred highlight functional code.

22. A method of setting a highlight window in an image reproducing system receiving a signal from a remote controller, the method comprising:
receiving a wirelessly transferred highlight functional code generated from the remote controller; and
generating a highlight window and video data representing an image to be displayed in the highlight window according to the wirelessly transferred highlight functional code.

23. The method of claim 22, wherein the receiving a wirelessly transferred highlight functional code comprises:
receiving one of a highlight on/off signal, a highlight window size control signal, a highlight window location control signal, and a video data parameter control signal.

24. The method of claim 23, wherein the image reproducing system is connected to one of an external monitor and an internal monitor each having a screen, and the generating a highlight window comprises:
adjusting one of a location and a size of the highlight window with respect to the screen according to a corresponding one of the highlight window size control signal and the highlight window location control signal.

25. The method of claim 23, wherein the generating of the video data comprises:
adjusting a parameter of the video data to emphasize the image included in the highlight window according to the video data parameter control signal.

26. The method of claim 25, wherein the adjusting of the parameter of the video data comprises:
highlighting the image displayed in the highlight window more than another image displayed on an outside of the highlight window in the screen.

27. A method of setting a highlight window in an image reproducing system receiving a signal from a remote controller, comprising:
receiving a wirelessly transferred highlight functional code generated from the remote controller; and
generating a first highlight window, a second highlight window, first video data representing a first image to be displayed in the first highlight window, and second video data representing a second image to be displayed in the second highlight window according to the wirelessly transferred highlight functional code.
